(19) United States
(12) Patent Application Publication
(10) Pub. No.: US 2011/0194554 A1
(43) Pub. Date: Aug. 11, 2011

(54) SYSTEMS AND METHODS FOR IMPLEMENTING CALL PICK UP USING GRUU AN IMS NETWORK

(75) Inventors: Edoardo GAVITA, Laval (CA); Madhi HIRAB, Pierrefonds (CA)

(73) Assignee: TELEFONAKTIEBOLAGET L M ERICSSON (PUBL), STOCKHOLM (SE)

(21) Appl. No.: 12/776,100

(22) Filed: May 7, 2010

Related U.S. Application Data
(60) Provisional application No. 61/303,151, filed on Feb. 10, 2010.

(51) Int. Cl. H04L 12/66

(52) U.S. Cl. 370/352

(57) ABSTRACT

A method and system for providing call pickup service in an IP Multimedia Subsystem (IMS) communication network is described. When call pickup is to be invoked, an IMS network node, e.g., a core network node or an application server, receives a Globally Routable User Agent URI (GRUU) associated with one of a plurality of devices which is to be used to pick up a call that is in the process of being placed to another device in a call pickup group. The IMS network node determines whether the one of the plurality of devices is authorized to pick up the call based, at least in part, on the received GRUU. Then, the IMS network node transmits a message to establish the call with that one of the plurality of devices.

### RELATED APPLICATION

This application is related to, and claims priority from, U.S. Provisional Patent Application Ser. No. 61/303,151, filed on Feb. 10, 2010, and entitled “Systems and Methods for Implementing Call Pickup Using GRUU in an IMS Network”, the disclosure of which is incorporated herein by reference.

### BACKGROUND

The IP Multimedia Subsystem (IMS) is an architectural framework for delivering Internet Protocol (IP) multimedia services. IMS was originally designed by the wireless standards body 3rd Generation Partnership Project (3GPP) as a part of the vision for evolving mobile networks beyond the GSM standards. The original formulation of IMS (3GPP R5) represented an approach to delivering Internet services over the data service which was added to GSM, i.e., General Packet Radio Service (GPRS).

Basically, the IMS network allows for an integration or convergence of networks in order to facilitate the use of IP packets for wireless and landline services, such as telephony, fax, email, internet access, web services, Voice over IP (VoIP), instant messaging (IM), videoconferencing, Video on Demand (VoD), etc. The ideal for many network operators is to migrate, from a circuit switched network for example, to a full IMS centric network which offers all of their services.

Today's circuit switched networks typically provide a number of so-called supplementary services in addition to basic call services. Such supplementary services include features like call forwarding, caller ID, and call pick-up, among others. In order to transition from circuit switched networks to IMS networks, solutions are needed to support, in an IMS network, all of the various supplementary services to which users have been accustomed.

Of particular interest for the present application is the call pickup service. The call pickup service allows one user to answer a call that is physically ringing in another telephone, device or user terminal than the one which he or she is currently using, e.g., a device located in another part of a large office. In this way, someone can answer a nearby phone for a colleague without having to physically walk over to another workstation or the like. The device whose call is being picked up could, for example, either belong to the user that is answering the call or to a group of users that belong to a team or project. However there is currently no network-based solution which is available to provide call pickup service in IMS networks.

Accordingly, it would be desirable to provide methods, systems, devices and software which facilitate the provision of call pickup service in IMS networks.

### SUMMARY

According to an exemplary embodiment, a method for providing call pickup service in an IP Multimedia Subsystem (IMS) communication network includes receiving, at an IMS network node, a Globally Routable User Agent URI (GRUU) associated with one of a plurality of devices which is to be used to pick up a call that is in the process of being placed to another of the plurality of devices, determining, by the IMS network node, that the one of the plurality of devices is authorized to pick up the call based, at least in part, on the received GRUU, and transmitting, by the IMS network node, a message to establish the call with the one of the plurality of devices.

According to another exemplary embodiment, a IMS network node includes an interface configured to receive a message including a Globally Routable User Agent URI (GRUU) associated with one of a plurality of devices which is to be used to pick up a call that is in the process of being placed to another of the plurality of devices, and a processor configured to determine that the one of the plurality of devices is authorized to pick up the call based, at least in part, on the received GRUU, wherein the processor is further configured to control the interface to transmit a message to establish the call with the one of the plurality of devices.

According to another exemplary embodiment, a method for initiating call pickup service in an IP Multimedia Subsystem (IMS) capable end user device includes receiving an input indicating that a call is to be picked up by the IMS capable end user device, and transmitting a call pickup request signal including a Globally Routable User Agent URI (GRUU) associated with the IMS capable end user device toward a call pickup application server.

According to still another exemplary embodiment, an IP Multimedia Subsystem (IMS) capable end user device includes a processor configured to receive an input indicating that a call is to be picked up by the IMS capable end user device, and an interface configured to transmit, in response to the input, a call pickup request signal including a Globally Routable User Agent URI (GRUU) associated with the IMS capable end user device toward a call pickup application server.

### BRIEF DESCRIPTION OF THE DRAWINGS

The accompanying drawings illustrate exemplary embodiments, wherein:

FIG. 1 illustrates an architecture of a portion of an IMS network according to an exemplary embodiment;

FIG. 2 is a diagram illustrating signaling associated with call pickup according to an exemplary embodiment;

FIG. 3 is a diagram illustrating signaling associated with registration and GRUUs according to an exemplary embodiment;

FIG. 4 is a flowchart depicting a method for providing call pickup service in an IP Multimedia Subsystem (IMS) communication network according to an exemplary embodiment;

FIG. 5 is a flowchart depicting another method for providing call pickup service in an IMS capable end user device according to an exemplary embodiment; and

FIG. 6 depicts a node in which exemplary embodiments can be implemented.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

As mentioned above, network operators who are transitioning from, e.g., circuit-switched networks, to IMS networks will likely want to be able to offer some or all of the supplementary services which they are currently offering to their subscribers. An example of such a service offered by a network operator is the call pickup service. However, in the more recently introduced IMS networks there are no simple, well-defined solutions for implementing call pickup functionality in a multi-device environment.

Generally stated, exemplary embodiments of the present invention use the Globally Routable User Agent URI (GRUU) in an IMS network, among other things, to provide call pickup service in a multi-device environment. By using the Globally Routable UA URI (GRUU) addressing scheme, a description of which can be found at the following location in the RFC document 5627 (http://tools.ietf.org/html/rfc5627), an application server can be provided in a network, for example, to route calls or messages to any User Agent device by using a Uniform Resource Identifier (URI), which in this case would be the GRUU. The GRUU addressing scheme introduces the ability in the application server to know which user, and correspondingly which of his or her devices are registered (i.e., online), at any given time. Moreover, these exemplary embodiments also enable the application server to make decisions associated with the call pickup service, and act on those decisions, at the network level based on the GRUU information, as will be described in detail below. This enables the application server to implement various network policies, e.g., authorization/authentication, that may be desirable by the network operator in the provision of this service.

More specifically, exemplary embodiments of the present invention use the GRUU as a mechanism to control how call pickup, in a multi-device environment, can be handled in an IMS network by using an application server. For example, the GRUUs of a subscriber can be used to control how, and when, a call pickup is executed for the subscriber that has multiple registered devices and wants to answer incoming calls on any of his or her registered devices, in an IMS network. Generally, the GRUU as used in these exemplary embodiments describes a new way of reflecting the users Address of Record (AOR) for a given registered device. In addition, the GRUU can be represented in two ways from a security perspective: encrypted and non-encrypted.

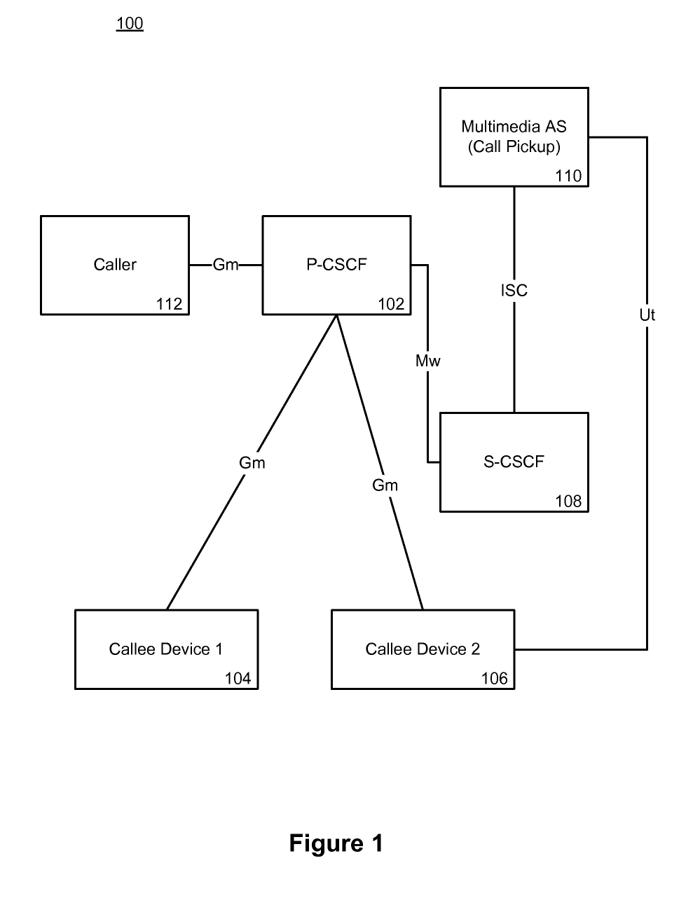

Now, turning to FIG. 1, a schematic architecture for a portion of an IMS network offering a call pickup service according to an exemplary embodiment will be described in order to provide some context for the subsequent discussion of the signaling associated with call pickup according to exemplary embodiments. Therein, the IMS network 100 includes a Proxy Call Session Control Function (P-CSCF) node 102 connected to a first device 104 and a second device 106 via Gm interfaces. These two devices 104 and 106 are associated with the same end user or group of end users such that they may be linked via the call pickup service. Those skilled in the art will appreciate that the number of devices in this call pickup group, or more generally which are connected to the IMS network 100, may vary and is not restricted to two devices.

The P-CSCF 102 provides for authentication of the users, among other functions, in the IMS network 100. As seen in FIG. 1, the P-CSCF 102 is also connected to a Serving Call Session Control Function (S-CSCF) node 108 via an Mw interface, which node provides switching/routing capabilities, among other functions. It should be noted that the IMS core network as represented by P-CSCF 102 and S-CSCF 108, as well as the Gm, Mw and other interfaces shown in FIG. 1, is well-known in the art per se and thus will not be described in further detail here.

Additionally, the S-CSCF 108 can provide the service of assigning and translating the GRUUs for use by the registered devices. This GRUU assignment and translation service can be conducted, for example, as specified in draft-ietf-sip-gruu-15 (October 2007): “Obtaining and Using Globally Routable User Agent (UA) URIs (GRUU) in the Session Initiation Protocol (SIP)” and draft-ietf-sipping-gruu-reg-event-09 (July 2007):“Registration Event Package Extension for Session Initiation Protocol (SIP0 Globally Routable User Agent URIs (GRUUs)”, the disclosures of which are incorporated here by reference. Each assigned GRUU represents an association between a public user identity (ID) and an instance ID provided by a registering device. The assigned GRUU is used to address a particular device that possesses the instance ID and registers with the public user identity. The GRUU can also denote a contact address registered with the public user identity when the contact address has a “+sip.instance” header field parameter containing the GRUU instance ID, for example.

IMS systems typically employ, as identifiers, IP addresses, which are physical identities tied to individual devices and which may undergo various translations throughout the system so as to not necessarily be readily available to the end user, and user identities, which are logical identities that are not directly tied to any particular device. The GRUUs thus provide a connection between each physical device and the logical identity of the corresponding user(s), which identifiers are implemented as URIs which route to a specific user agent instance and can, therefore, be used according to these exemplary embodiments to support call pickup services in conjunction with a scenario wherein multiple devices are related to a particular user or group of users and wherein it is desirable to enable an end user device to directly contact an application server to execute a call pickup in a manner which is controllable and verifiable by the network. A purely illustrative example of such a GRUU which is associated with a user agent (which is in turn associated with a particular end user device) is:

sip:bob@vertigo.com;gruu;opaque=user:id:XXXXXXXXXXXX

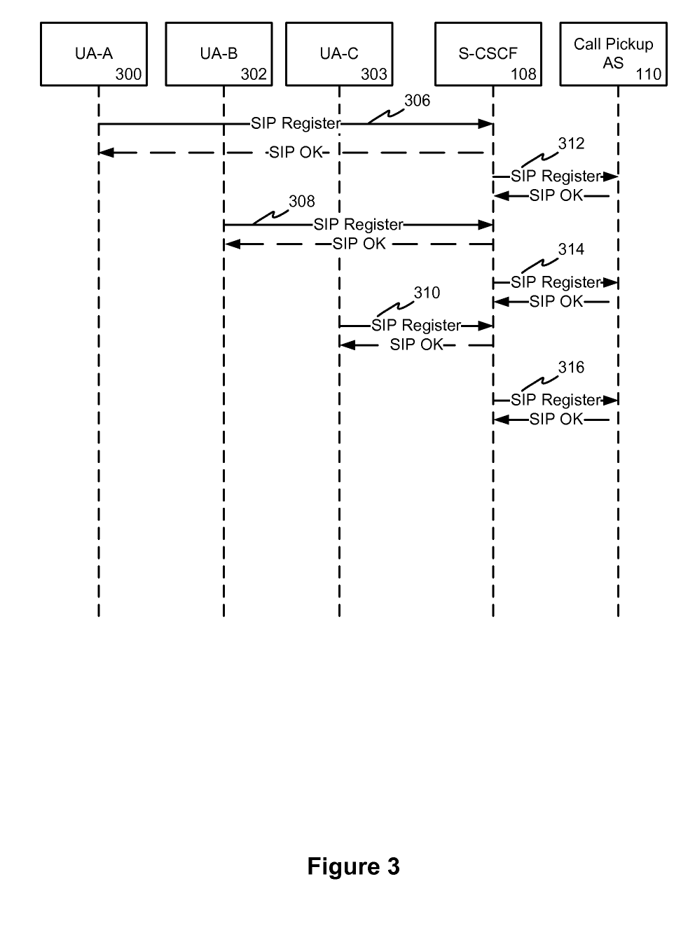

The S-CSCF 108 issues GRUUs as part of the registration process, and also reports GRUUs as part of the notifications for subscriptions to the “reg” event package, for example. The S-CSCF 108 generally issues GRUUs in pairs—a public GRUU (or permanent GRUU) and a temporary GRUU. In case of implicit registration, the S-CSCF 108 assigns a unique public GRUU and a unique temporary GRUU for each public user identity. A more detailed discussion of registration involving GRUUs in the context of these exemplary embodiments is provided below with respect to FIG. 3.

As shown in FIG. 1, the IMS network 100 further comprises a MultiMedia Application Server (MM-AS) 110, which provides the call pickup service according to this exemplary embodiment and which is sometimes also referred to herein as a “call pickup application server”. The MM-AS 110 may be an independent node, or may be merged with another application server or with an IMS core network node, e.g., S-CSCF 108. For the purposes of this text, the node which manages provision of the call pickup service is referred to generically as “an IMS network node” to reflect the network-centric aspect of some of these exemplary embodiments, such that “IMS network nodes” include all of the afore-stated physical implementations of an MM-AS 110 (and others).

Regardless of where it is located, the functionality associated with MM-AS 110 provides overall network management of the call pick-up service according to these exemplary embodiments based, at least in part, on certain information which it collects via a third party registration process. For example, the multimedia AS 110 can request a third-party registration of users from the S-CSCF 108 for all the subscribed users in the IMS network 100. The S-CSCF 108 will thus, after a successful registration by a user or user device, send a third-party SIP REGISTER message to the MM-AS 110 with the following information: the To-header which contains a non-barred public user identity belonging to the service profile, and, for an initial registration, the registration expiration interval value. This information can be stored and used by the multimedia AS 110 to, for example, track the users and enforce security associated with the provision of the call pickup service.

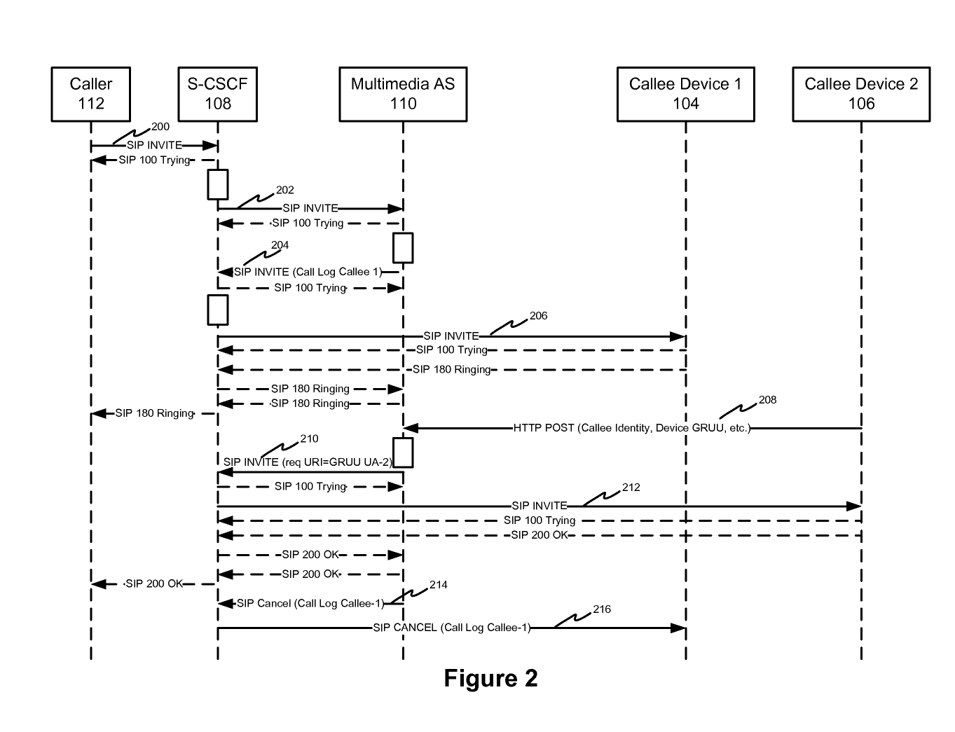

A detailed, yet purely exemplary, signaling embodiment by way of which an MM AS 110 provides call pickup service associated with a caller's device 112 and callee devices 104 and 106, will now be described with respect to FIG. 2. In this exemplary embodiment, it is assumed that both the caller and the callee are properly registered with respective devices, such as device 104 and 106 for the callee, in the IMS network 100 through the S-CSCF 108 and that all of the devices 104, 106 and 112 have at least one GRUU associated therewith (i.e., either a permanent or temporary GRUU). It is also assumed that the multimedia AS 110 has knowledge about the registration status of these devices and that the S-CSCF 108 has handed over proper temporary/permanent GRUU(s) to the callee and the caller. More details regarding these preliminary registration steps will be described with respect to FIG. 3 below.

The signaling process shown in FIG. 2 starts when the caller 112 calls the callee. The incoming call is handled by the S-CSCF 108 which receives a SIP INVITE request 200 from the caller 112, for example. Then, the S-CSCF 108 sends a SIP INVITE 202 request to the MM AS 110. As a purely illustrative example, SIP INVITE message 202 could include the following information shown in Table 1.

TABLE 1

INVITE sip: or tel: URI SIP/2.0
Via: scscf, pcscf and A-SBC
Via: UE Caller address;receivedUE A
Max-Forwards: 69
Route: <”as”,call=orig,msisdn”nnnn>
Route:<”session-id”@”orig scscf:port”>
Record-Route: <sip:scscf1.home1.net;lr>
Accept-contact:<icsi feature tag>
P-Asserted-Identity: tel:+IMCN

According to some exemplary embodiments, when the MM AS 110 is provided in the IMS network 100 as a separate node, e.g., relative to the S-CSCF 108, the MM AS 110 will receive all incoming calls for processing. Note that the dotted lines in FIGS. 2 and 3 represent acknowledgement signals which are otherwise undescribed herein.

The MM AS 110 operates as a routing B2B user agent for the callee and, thus, performs a number of operations upon receipt of a call from the S-CSCF 108. For example, upon receipt of the request 202, the MM AS 110 is triggered and creates and stores a call context which contains call state information including, for example, identification of the caller and callee, and the status of the call (e.g., ringing/alerting, call established, call terminated, etc.). The MM AS 110 can also execute terminating services associated with the incoming call, including but not limited to the call pickup service of interest herein. The MMAS 110 may also create a new call leg for the incoming call. Those skilled in the art will appreciate that the foregoing operations associated with the MM AS 110 are exemplary and that more or fewer operations can be performed by this node.

Upon completion of its tasks associated with new call handling, the MM AS 110 then returns a SIP INVITE message 204 including this information back to the S-CSCF 108. A purely illustrative example of a SIP INVITE message 204 is provided in Table 2 below.

TABLE 2

INVITE sip: or tel: URI SIP/2.0
Via: scscf, pcscf and A-SBC
Max-Forwards: 69
Route:<”session-id”@”orig scscf:port”>
Contact:”identity@SIPAS”
Accept-contact:<icsi feature tag>

The S-CSCF 108 selects an initial device within the call pickup group to attempt to establish the call, e.g. device 104, based upon, for example, the feature tag that the S-CSCF 108 receives in SIP INVITE message 204 and then sends a SIP INVITE 206 toward the selected device 104 to alert the callee of the incoming call from caller device 112. More specifically, during the registration phase, each device (or device's user agent) specifies the communication services that they are capable of processing by using the feature tag (e.g. IMS Communication Service Identifiers (ICSI), Open Mobile Alliance (OMA) messaging, etc.). This information is stored in the S-CSCF 108 by, for example, a registrar function, which information is then used to select the initial device for establishing the call. At this point, the device 104 will begin ringing or otherwise indicating the presence of an incoming call.

However, as shown in FIG. 2, if the user/callee decides to pick up his or her incoming call from device 106 instead of device 104, e.g., by pressing a button on the device 106, then the device 106 will send an HTTP POST message 208 to the multimedia AS 110. This HTTP POST request 208 can contain, for example, the callee ID in the X-UI header, and the GRUU(s) assigned to the device 106. It should be understood by those skilled in the art that protocols other than HTTP (e.g., SIP) could be also used to send such a request 208, albeit use of HTTP may reduce the complexity of call pickup service processing by MM AS 110 particularly if MM AS 110 is not co-located with, or integrated into, S-CSCF 108.

Once the MM AS 110 receives the HTTP POST 208, it will authenticate the user (callee) 106 using, for example, the X-UI parameters in message 208 such as P-Asserted-Identity, Group, GRUU, etc. MM AS 110 can also check to see if the GRUU(s) in the HTTP POST message 208 belong to the user based on the information which the MM AS 110 stores as part of the registration process described below. Then, the MM AS 110 will determine whether the user requesting the call transfer actually has an ongoing alerting call. Assuming, for this example, that these determinations are all positive, the MM AS 110 can then determine whether the call has already been answered.

Assuming also for this example that the call has not yet been answered at device 104 (which case is illustrated in FIG. 2), then the multimedia AS 110 will establish the call with the device 106 by, for example, initiating a new SIP INVITE 210 toward the S-CSCF 108 that contains the call identity and, as the Request URI, the GRUU received in the HTTP Post 208, i.e., identifying device 106 as the new call recipient. In response, the S-CSCF 108 sends a SIP INVITE message 212 to callee device 106 to establish the call from caller 112 with device 106 instead of device 104. Once the MM AS 110 is informed of a successful call establishment to device 106, i.e., as indicated by the SIP 200 OK message from callee device 106 to the S-CSCF 108, and then from the S-CSCF 108 to the MM AS 110, the MM AS 110 will cancel the call toward the first callee device 104 by sending a SIP CANCEL message 214 associated with that call leg to S-CSCF 108. The S-CSCF 108 then sends a corresponding SIP CANCEL message 216 on to callee device 104 and the rest of the call flow (not shown in FIG. 2) continues on in a conventional manner between caller 112 and callee device 106.

As mentioned above, a significant feature of providing call pickup service in an IMS network using GRUUs is the capability for the network node which is controlling the service management, e.g., MM AS 110, to authenticate the request by a callee device to pickup the call prior to establishing the call toward that callee device. Part of this capability is provided by performing third party registration toward the MM AS 110, an example of which will now be described with respect to FIG. 3.

FIG. 3 shows a flow diagram of a registration process of the caller 112 and callee devices 104 and 106 in the IMS network 100 according to an exemplary embodiment. Therein, there are shown, for example, three user agents 300, 302, 303 (e.g. UA-A 300, UA-B 302 and UA-C 303), which desire to register with the S-CSCF 108 in the IMS network 100. These user agents can, for example, correspond to the devices 112, 104 and 106, respectively, described above with respect to FIGS. 1 and 2. Each of these user agents 300, 302, 303 sends a respective SIP REGISTER message 306, 308 and 310 to the S-CSCF 108 for that purpose. In each of the register requests 306, 308 and 310, a GRRU is requested by adding, for example, the “+sip.instance” parameter in the contact header within the SIP REGISTER message. Once the S-CSCF 108 receives the SIP REGISTER message 306, 308, 310, the S-CSCF 108 detects the “+sip.instance” parameter and then generates, for example, a pair of GRUUs for each user agent 300, 302, 303, i.e., a temporary GRUU and a permanent GRUU. The pair of generated GRUUs is assigned respectively to each of the user agents 300, 302 and 303 and the S-CSCF 108 then sends a SIP 200 OK message to each of the user agents 300, 302 and 303 which includes their respective, assigned GRUUs.

More specifically, the S-CSCF 108, when receiving a registration request 306, 308, 310 from a User Agent or UE that includes an instance id, shall allocate a GRUU set. If the User Agent or UE indicates support of GRUU in the REGISTER request, then the S-CSCF 108 returns the permanent and temporary GRUU set (P-GRUU+T-GRUU) in the registration response and associates that GRUU set with the registered contact information for that UE. As long as the instance id provided in the register request is the same, the resulting P-GRUU in the GRUU set will always be the same for a given public user identity. The T-GRUU will be different from those returned during previous re-registrations. All T-GRUUs that are allocated continue to remain valid until that UE Instance ID and Public User Identity pair are deregistered. If there are implicitly registered public user identities, the S-CSCF 108 generates a GRUU set for each implicitly registered public user identity and includes the corresponding GRUU set with the notification of each implicitly registered public user identity

In addition to assigning and providing the GRUUs to the user agents/end user devices, exemplary embodiments also provide these identifiers to the MM AS 110 which requests a third party registration from the S-CSCF 108. Thus, as shown in FIG. 3, once a user agent 300, 302, 303 is registered with the S-CSCF 108, the S-CSCF 108 sends a SIP REGISTER message 312, 314, 316 to the multimedia AS 110 which provides the call pickup service. Upon receipt of the SIP REGISTER messages 312, 314, 316, the multimedia AS 110 replies back with a respective SIP 200 OK. The MM AS 110 also stores all of the GRUUs received from the S-CSCF 108, along with identifying information associated with the corresponding user agent, in order to implement the earlier described authentication of call pickup requests from callees without, for example, having to reference other databases in the network, although in some implementations of these exemplary embodiments it may also be necessary for the MM AS 110 to reference other databases to implement its call pickup service.

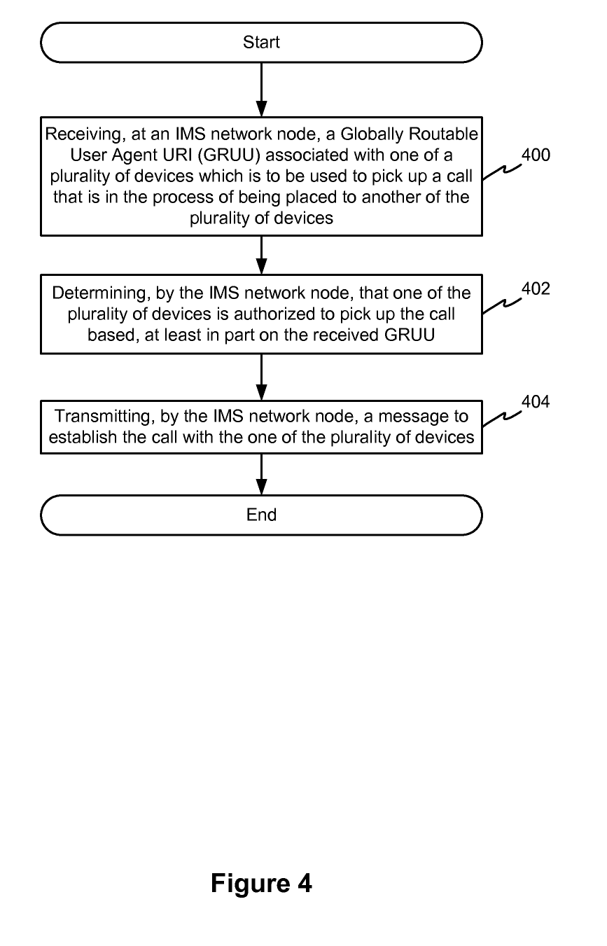

FIG. 4 is a flowchart describing a method for providing call pickup service in an IP Multimedia Subsystem (IMS) communication network according to an exemplary embodiment. Therein, at step 400, a Globally Routable User Agent URI (GRUU) associated with one of a plurality of devices which is to be used to pick up a call is received at an IMS node, e.g., MM AS 110 as part of the HTTP POST message 208 discussed above. The IMS node determines, at step 402, that this device is authorized to pickup said call based on the received GRUU. Next, the IMS network node establishes the call with that one of the plurality of devices at step 404.

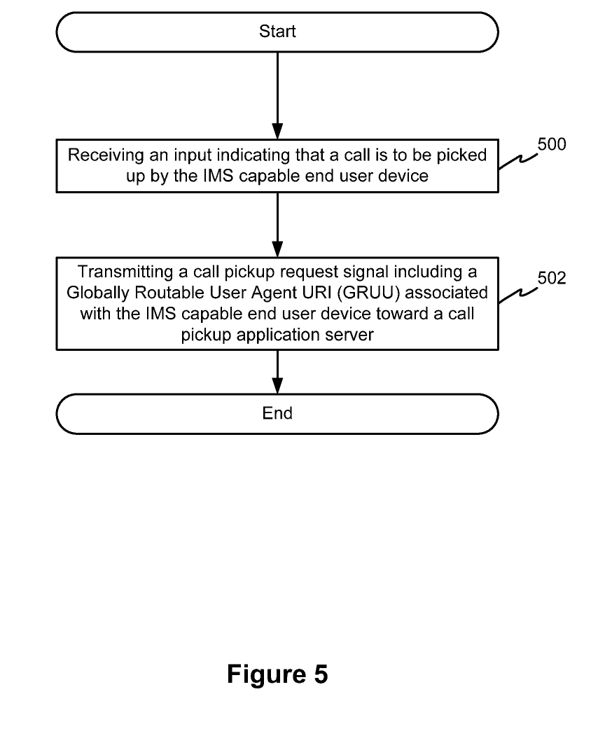

FIG. 5 is a flowchart illustrating a method for initiating call pickup service in an IP Multimedia Subsystem (IMS) capable end user device, the method including receiving an input indicating that a call is to be picked up by the IMS capable end user device at step 500. Then, at step 502, a call pickup request signal including a Globally Routable User Agent URI (GRUU) associated with the IMS capable end user device is transmitted toward a call pickup application server.

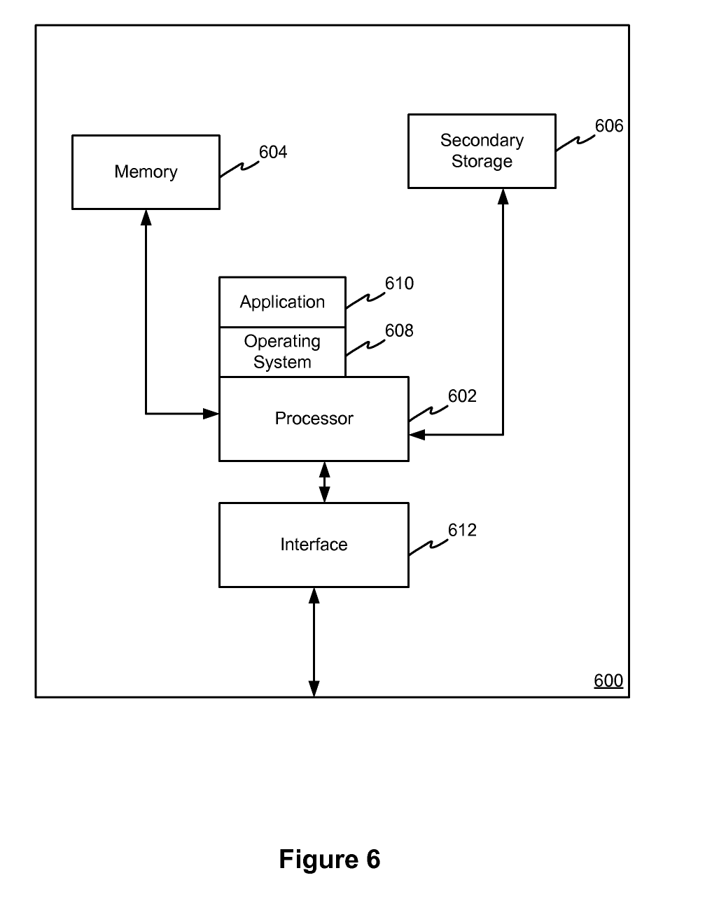

The exemplary embodiments described above relate to methods and systems for providing a call pickup service to user equipment in IMS networks which involves the cooperation of several nodes in the system, including (at least in some embodiments) the end user devices 104, 106, 112, the S-CSCF 108, and the MM AS 110. Such nodes can, at a high level, be architected in a manner which is generally represented by communications node 600 shown in FIG. 6. Therein, node 600 can contain a processor 602 (or multiple processor cores), memory 604, one or more secondary storage devices 606 and a communications interface 612. In the context of an end user device 104, 106, 112, e.g., a SIP-enabled telephone or device, the communications node 600 is capable of running a user agent 300, 302, 303 as a software application 610 running on an operating system 608 of the end user device 104, 106, 112. Additionally, in the context of an end user device 104, 106, 112, the communications interface 612 can include a wireless transceiver for receiving and transmitting signals via an air interface, as well as a display for displaying messages to the user regarding, e.g., incoming calls that qualify for the call pickup service described above.

Alternatively, in the context of an IMS network node, e.g., MM AS 110 or S-CSCF 108, the processor 602 can run an application 610 which handles call pickup services, including a trigger for performing the afore-describe routing B2B agent steps described above when it receives a SIP INVITE associated with a new call. In such a case memory 604 and/or secondary storage device 606 will contain a database or other data structure which been designed to capture the GRUU information, and other information, which the MM AS 110 receives as part of the third party registration process and which the node 600 then uses to authenticate requests for call pickup as described above.

A network centric approach (as opposed to using a terminal centric approach, for example) through the use of a call pickup application server in the network is described in the foregoing exemplary embodiments in order to control the way calls are picked up in a multi-device environment. However, the present invention is not restricted to such an implementation and, for example, a terminal centric approach may be implemented instead. On the other hand, some advantages of using a network centric approach for services such as the call pickup service, include the capability for a network operator to easily control the way its subscribers can be reached, through a centralized application server which is programmable. Also, since the services are implemented in the operator's network, an end-user can define a personal profile that describes which devices he or she has and how or when he or she wants to be reached on these devices. The network operator can define this profile on the user's behalf and charge for this service on a monthly or even package level, for example.

Furthermore, the use of GRUUs for carrying registration information into the call pickup application, and thereby enabling the application server to decide to which device and when to redirect call requests, offers a security mechanism by encrypting the URI for each device before it is propagated, if required. As a result, the network operator can be assured that its offered services are secure. In addition to redirecting and authenticating calls, application server can also introduce intelligence to the call sequence flows when, for example, the callee issues an HTTP POST that requests a call pickup. For example, suppose that the MM AS 110 receives an HTTP POST from a device that only supports voice content, but the caller that issued the call is requesting to communicate via video. In this situation, the MM AS 110 will know the device characteristics of the callee's device and can attempt to negotiate with the callee, e.g., the MM AS can offer the option to either downgrade the call to a voice call or simply reject the call.

Various modifications and other embodiments of the disclosed invention will come to mind to one skilled in the art having the benefit of the teachings presented in the foregoing description and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

1. A method for providing call pickup service in an IP Multimedia Subsystem (IMS) communication network, the method comprising:
receiving, at an IMS network node, a Globally Routable User Agent URI (GRUU) associated with one of a plurality of devices which is to be used to pick up a call that is in the process of being placed to another of said plurality of devices;
determining, by said IMS network node, that said one of said plurality of devices is authorized to pick up said call based, at least in part, on said received GRUU; and
transmitting, by said IMS network node, a message to establish the call with said one of said plurality of devices.

2. The method of claim 1, wherein said GRUU is a URI which provides a unique route to a user agent associated with said one of said plurality of devices.

3. The method of claim 1, wherein said IMS network node is one of a Serving Call Session Control Function (S-CSCF) node and a call pickup application server.

4. The method of claim 1, wherein said plurality of devices are associated with a group among which a call directed to said another of said plurality of devices can be redirected for pickup using said call pickup service to said one of said plurality of devices.

5. The method of claim 3, wherein said IMS network node is a call pickup application server, the method further comprising:
receiving, at said call pickup application server, a registration message associated with a user agent of said one of said plurality of devices, said registration message including a feature tag indicating at least one capability of said one of said plurality of devices.

6. The method of claim 3, wherein said IMS network node is a call pickup application server, the method further comprising:
receiving, at said call pickup application server, a SIP message associated with placing said call;
creating, by said call pickup application server, a call context and a new call leg associated with said call; and
transmitting, by said call pickup application server, a SIP message including a feature tag toward said S-CSCF node.

7. The method of claim 6, further comprising:
receiving, by said S-CSCF node, said SIP message including said feature tag;
selecting, by said S-CSCF node, said another of said plurality of devices for initial placement of said call based on said feature tag; and
sending, by said S-CSCF node, a first SIP INVITE message toward said another of said plurality of devices.

8. The method of claim 7, wherein said step of transmitting, by said IMS network node, a message to establish the call with said one of said plurality of devices further comprises:
sending, by said call pickup application server, said message to said S-CSCF node; and
transmitting, by said S-CSCF node, a second SIP INVITE message toward said one of said plurality of devices to establish said call.

9. The method of claim 1, further comprising:
transmitting, by said IMS network node, a cancel message to cancel said call to said another of said plurality of devices after said call has been established with said one of said plurality of devices.

10. An IMS network node comprising:
an interface configured to receive a message including a Globally Routable User Agent URI (GRUU) associated with one of a plurality of devices which is to be used to pick up a call that is in the process of being placed to another of said plurality of devices; and
a processor configured to determine that said one of said plurality of devices is authorized to pick up said call based, at least in part, on said received GRUU,
wherein said processor is further configured to control said interface to transmit a message to establish the call with said one of said plurality of devices.

11. The IMS network node of claim 10, wherein said GRUU is a URI which provides a unique route to a user agent associated with said one of said plurality of devices.

12. The IMS network node of claim 10, wherein said IMS network node includes at least one of a Serving Call Session Control Function (S-CSCF) node and a call pickup application server.

13. The IMS network node of claim 10, wherein said IMS network node further comprises said plurality of devices and wherein said plurality of devices are associated with a group among which a call directed to said another of said plurality of devices can be redirected for pickup using said call pickup service to said one of said plurality of devices.

14. The IMS network node of claim 12, wherein said IMS network node includes said call pickup application server having said interface and said processor, and wherein said interface is further configured to receive a registration message associated with a user agent of said one of said plurality of devices, said registration message including a feature tag indicating at least one capability of said one of said plurality of devices.

15. The IMS network node of claim 12, wherein said IMS network node includes said call pickup application server having said interface and said processor, wherein said interface is further configured to receive a SIP message associated with placing said call, wherein said processor is further configured to create a call context and a new call leg associated with said cal, and wherein said processor is further configured to control said interface to transmit a SIP message including a feature tag toward said S-CSCF node.

16. The IMS network node of claim 15, wherein said IMS network node includes said S-CSCF node which is configured to receive said SIP message including said feature tag, select said another of said plurality of devices for initial placement of said call based on said feature tag and sending a first SIP INVITE message toward said another of said plurality of devices.

17. The IMS network node of claim 16, wherein said processor in said call pickup application server is further configured to control said interface to send said message to said S-CSCF node, wherein said S-CSCF node is further configured to transmit a second SIP INVITE message toward said one of said plurality of devices to establish said call.

18. The IMS network node of claim 10, wherein said processor is further configured to control said interface to transmit a cancel message to cancel said call to said another of said plurality of devices after said call has been established with said one of said plurality of devices.

19. A method for initiating call pickup service in an IP Multimedia Subsystem (IMS) capable end user device, the method comprising:
receiving an input indicating that a call is to be picked up by said IMS capable end user device; and
transmitting a call pickup request signal including a Globally Routable User Agent URI (GRUU) associated with said IMS capable end user device toward a call pickup application server.

20. The method of claim 19, further comprising:
registering, by said IMS capable end user device, to obtain said GRUU.

21. An IP Multimedia Subsystem (IMS) capable end user device comprising:
a processor configured to receive an input indicating that a call is to be picked up by said IMS capable end user device; and
an interface configured to transmit, in response to said input, a call pickup request signal including a Globally Routable User Agent URI (GRUU) associated with said IMS capable end user device toward a call pickup application server.

22. The IMS capable end user device of claim 21, wherein said processor is further configured to control said interface to transmit a registration signal to obtain said GRUU.
